(19) United States
(12) Patent Application Publication
(10) Pub. No.: US 2016/0305578 A1
(43) Pub. Date: Oct. 20, 2016

(54) PLASTIC PIPE AND PRODUCTION METHOD THEREFOR

(71) Applicants: Andreas Bersch, (US); Michael TAPPE, Düsseldorf (DE)

(72) Inventor: Michael Tappe, Düsseldorf (DE)

(21) Appl. No.: 15/101,651

(22) PCT Filed: Dec. 2, 2014
(86) PCT No.: PCT/EP2014/076295

§ 371 Date: Jun. 3, 2016

(30) Foreign Application Priority Data
Dec. 6, 2013 (DE) 10 2013 113 664.8
Apr. 15, 2014 (DE) 10 2014 105 338.9

(51) Int. Cl. F16L 9/128; B32B 27/34; B32B 27/32; B32B 1/08; B32B 5/02

(52) U.S. Cl. CPC F16L 9/128; B32B 1/08; B32B 5/028; B32B 27/32; B32B 27/34; B32B 2597/00

(57) ABSTRACT

A plastic pipe, and method for producing a plastic pipe, in the form of a high-pressure pipe, having a pipe wall with a first layer made of a plastic and a reinforcing structure arranged in the pipe wall. The reinforcing structure has a tubular design and is embedded in the first layer.

The present application claims the priority benefits of International Patent Application No. PCT/EP2014/076295, filed Dec. 2, 2014, and claims benefit of DE 102014105338.9, filed on Apr. 15, 2014, and DE 102013113664.8, filed on Dec. 6, 2013.

### BACKGROUND OF THE INVENTION

The invention relates to a synthetic material pipe, which is formed as high-pressure pipe, comprising a pipe wall, which includes a first layer consisting of a synthetic material, and a reinforcing structure arranged in the pipe wall, and to a production method therefor.

German patent document DE 601 21 579 T2 discloses a synthetic material pipe which comprises a laminated and multi-layered pipe wall. A first layer of the pipe wall is formed by an inner carrier pipe consisting of synthetic material. In the longitudinal direction of the carrier pipe, the carrier pipe is wound in a spiral manner using a reinforcing tape consisting of a cord fabric. The reinforcing tape subsequently wound on the carrier pipe is coated with an adhesive and connected thereby to the carrier pipe. Finally, a second layer of synthetic material is extruded around the thus laminated carrier pipe in order to protect the reinforcing tape on the outer side.

In a comparable manner, multi-layered synthetic material pipes having a wound reinforcing tape consisting of synthetic material are also known from international patent application WO 2009/109609 A1 and German utility model document DE 202 19 222 U1. A corresponding multi-layered synthetic material pipe having a wound reinforcing wire is known from German utility model document DE 1 813 312 U.

In terms of the present invention, the expression “layer consisting of a synthetic material” in relation to a pipe wall of a synthetic material pipe refers to that material consisting of an identical synthetic material which is solidified conjointly from a plasticised, molten state and thus becomes a supporting component of the pipe wall.

The synthetic material pipes known from the aforementioned documents all comprise a multi-layered structure in accordance with this understanding of the term “layer”, the individual layers, consisting of synthetic material, of said structure being produced by a plurality of successively performed extrusion steps and each being solidified separately in individual method steps. Accordingly, the respective reinforcing structures are arranged between two successively produced layers of the corresponding pipe wall.

### SUMMARY OF THE INVENTION

The object of the invention is to provide an improved synthetic material pipe, which is formed as a high-pressure pipe, comprising a pipe wall, which includes a first layer consisting of a synthetic material, and a reinforcing structure arranged in the pipe wall, the structure and mechanical properties of which being optimised. A further object is to provide a simple method of producing a corresponding reinforced synthetic material pipe.

In accordance with an embodiment of the invention, a synthetic material pipe, which is formed as a high-pressure pipe, comprising a pipe wall, which includes a first layer consisting of a synthetic material, and a reinforcing structure arranged in the pipe wall, is improved by virtue of the fact that the reinforcing structure is formed in a tubular manner and is embedded in the first layer. Corresponding high-pressure pipes are particularly designed for conducting fluids, preferably oil, water or gas, at a pressure of up to 60 bar. Owing to the embedded reinforcing structure, the synthetic material pipe comprises an improved compression resistance and reduced strain. Also, the pipe wall can have a reduced wall thickness with the load bearing capacity, in particular compressive strength, remaining the same. Furthermore, the reinforcing structure embedded in the first layer permits, in a particularly advantageous manner, that so-called weld fittings or clamp fittings can be used to connect two successive synthetic material pipe ends. In contrast, synthetic material pipes in which the reinforcing structure is not embedded in a layer but is arranged between two successive layers must be connected using so-called butt welds. Weld fittings or clamp fittings cannot be used in that case because otherwise the medium conducted through the synthetic material pipes can enter the connecting region between the layers and the reinforcing structure and can destroy the synthetic material pipes.

The reinforcing structure is also embedded in the layer of the pipe wall in a stable manner by virtue of the fact that the reinforcing structure has varying distances to an inner surface and an outer surface of the first layer. By virtue of the fact that the reinforcing structure is preferably formed in a mesh-like manner and in particular has openings, the reinforcement of the pipe wall is increased and the reinforcing structure is embedded in the layer in a particularly stable manner because the synthetic material of the layer penetrates the openings.

The embedding of the reinforcing structure is further improved by virtue of the fact that the first layer at least partially extends continuously between the inner surface and the outer surface, in particular in the region of openings in the reinforcing structure.

In an advantageous manner, provision is made that the synthetic material of the first layer includes EVOH, polyamide, in particular polyamide 12, polyethylene, in particular an LDPE or an HDPE, or a compound consisting of polyethylene, in particular an LDPE or an HDPE, and polyamide, in particular polyamide 12. If the first layer contains the aforementioned EVOH or preferably polyamide material, then in an advantageous manner the gas permeability is hereby reduced, in particular at high pressure stages, and the oil resistance is increased. In this manner, the first layer forms a chemically resistant barrier layer, i.e. in particular chemically resistant to acids, bases and hydrocarbons, in relation to the fluids conducted through the synthetic material pipe under high pressure. EVOH would be particularly useable with respect to helium or hydrogen. If the first layer contains the aforementioned PA and/or PE material, then the mechanical properties of the synthetic material pipe required with respect to the high pressure prevailing within the synthetic material pipe are hereby ensured.

In a structurally simple design, provision is further made that the pipe wall includes, in addition to the first layer in which the reinforcing structure is embedded, a second layer consisting of a synthetic material which is arranged preferably on the outside on the first layer and the synthetic material of the second layer includes EVOH, polyamide, in particular polyamide 12, polyethylene, in particular an LDPE or an HDPE, or a compound consisting of polyethylene, in particular an LDPE or an HDPE, and polyamide, in particular polyamide 12, and preferably the reinforcing structure includes polyethylene and preferably the first layer and the second layer are connected via an adhesion promoter consisting of a synthetic material which preferably includes a thermoplastic material, in particular anhydride-modified ethylene. The first layer is hereby advantageously used as a protective layer for the reinforcing structure embedded therein, in particular with respect to influences caused by the production technique, described hereinafter, as a result of the second layer. Moreover, by correspondingly selecting or combining different synthetic materials, a synthetic material pipe can be provided which has optimum properties in terms of the medium conducted at high pressure. If the first layer includes EVOH or PA, in particular PA12, the first layer simultaneously forms a barrier layer. The second layer then preferably includes PE, in particular HDPE, or PA12 in order to ensure the mechanical properties, in particular high strength, required in terms of the high pressure prevailing within the synthetic material pipe. The mechanical properties of the synthetic material pipe are also improved by the PE-comprising reinforcing structure. If the first layer includes EVOH, the second layer can also include—instead of PE—PA, in particular PA12 because this has a higher strength than PE. In this case, the two layers would simultaneously each also be used as a barrier layer. The first layer is connected to the second layer on a molecular level, and thus in an integrally bonded manner, via the adhesion promoter. Moreover, preferably, the inner first layer is formed as a barrier layer and the second layer consisting of thermoplastic synthetic material is provided on the outside on the first layer in order to be able to weld a plurality of pipe sections together.

In a structurally simple design, provision is further made that the pipe wall includes, in addition to the second layer, a third layer which is preferably arranged on the outside on the second layer and the synthetic material of the third layer includes EVOH, polyamide, in particular polyamide 12, polyethylene, in particular an LDPE or an HDPE, or a compound consisting of polyethylene, in particular an LDPE or an HDPE, and polyamide, in particular polyamide 12, and preferably the second layer and third layer are connected via an adhesion promoter consisting of a synthetic material which preferably includes a thermoplastic material, in particular anhydride-modified ethylene. In this case, the second layer preferably forms a barrier layer and includes the aforementioned PA, in particular PA12, or EVOH material. The first and third layers can each contain one of the aforementioned synthetic materials and in particular also the same synthetic material, but preferably a synthetic material different from that of the second layer. Owing to the synthetic materials which then differ from layer to layer, the second layer is also connected to the third layer via the adhesion promoter. In this manner, in principle a barrier layer can be formed by all, some, or individual ones of the three layers in each case. The reinforcing structure is preferably embedded in the innermost layer in relation to the synthetic material pipe.

In accordance with another aspect of the invention, a method for producing a synthetic material pipe, in particular one of the aforementioned synthetic material pipes, which is formed as a high-pressure pipe, is improved by virtue of the fact that in a first method step a tubular reinforcing structure is embedded in a first layer consisting of a molten synthetic material. A corresponding reinforced high-pressure pipe consisting of synthetic material can hereby advantageously be produced in merely one working cycle in that the production and reinforcement of a layer consisting of molten, and thus fusible, synthetic material of the pipe wall can occur simultaneously. This has the further advantage that the tubular reinforcing structure can be produced independently of the production of the synthetic material pipe in advance and not only by winding which occurs during the production of second layers.

In an advantageous manner, provision is made that the synthetic material of the first layer includes EVOH, polyamide, in particular polyamide 12, polyethylene, in particular an LDPE or an HDPE, or a compound consisting of polyethylene, in particular an LDPE or an HDPE, and polyamide, in particular polyamide 12. Said synthetic materials can be processed efficiently.

In an advantageous manner, provision is additionally made that in a second method step the molten first layer and the reinforcing structure embedded therein are formed into a tubular shape by means of a shaping tool. In this manner, the first layer is formed into the desired tubular shape and dimensions together with the prefabricated tubular reinforcing structure embedded in the first layer.

In a simple manner, provision is additionally made that in a third method step the first layer is solidified. As a result, the solidification of the synthetic material of the first layer in which the reinforcing structure is embedded is directly associated with the reinforcement thereof and concludes with the solidification. Therefore, it is no longer necessary to successively perform a plurality of steps for producing and reinforcing a synthetic material pipe, in that initially a carrier pipe is extruded, this pipe can be provided with a reinforcing structure, e.g. by winding with a reinforcing tape, only after sufficient solidification of the plasticised synthetic material, and then the reinforcing structure is fixed and protected by extruding a further layer consisting of synthetic material.

In a particularly advantageous manner, the method for producing a synthetic material pipe with a reinforcing structure arranged in a pipe wall can be shortened by virtue of the fact that the reinforcing structure embedded in the layer is fixed by the third method step in the pipe wall, in particular in the first layer. Further method steps for embedding or fixing the reinforcing structure are thus not necessary.

In a manner which is simple in terms of the method, provision is made that in a fourth method step a second layer consisting of a molten synthetic material is applied onto the first layer, preferably on the outside, and the synthetic material of the second layer includes EVOH, polyamide, in particular polyamide 12, polyethylene, in particular an LDPE or an HDPE, or a compound consisting of polyethylene, in particular an LDPE or an HDPE, and polyamide, in particular polyamide 12, and preferably the reinforcing structure includes polyethylene and preferably an adhesion promoter consisting of a molten synthetic material is introduced between the first layer and the second layer and preferably includes a thermoplastic material, in particular anhydride-modified ethylene. Therefore, resistant but heat-sensitive material such as, for example, polyethylene can also be used for the reinforcing structure because the first layer is then used as a protective layer, in particular as a heat protection layer, for the subsequently applied second layer, provided that the synthetic material of the first layer can be plasticised at a temperature lower than the temperature which is critical for the reinforcing structure and, after solidification, prevents damage to the reinforcing structure owing to higher temperatures of the second layer applied in molten form. For the remainder, the advantages mentioned above in relation to the synthetic material pipe are produced by the corresponding material selection.

In an advantageous manner, provision is further made that in a fifth method step a third layer consisting of a molten synthetic material is applied onto the second layer, preferably on the outside, and the synthetic material of the third layer includes EVOH, polyamide, in particular polyamide 12, polyethylene, in particular an LDPE or an HDPE, or a compound consisting of polyethylene, in particular an LDPE or an HDPE, and polyamide, in particular polyamide 12, and preferably an adhesion promoter consisting of a molten synthetic material is introduced between the second layer and the third layer and preferably includes a thermoplastic material, in particular anhydride-modified ethylene. The advantages mentioned above in relation to the synthetic material pipe are also produced by the corresponding material selection.

In a particularly economic manner, the method can be performed by virtue of the fact that the method is performed in an extrusion method to which the tubular reinforcing structure is continuously supplied.

The method can be performed in an alternative economic manner in that the method is performed in an injection moulding method to which the tubular reinforcing structure is supplied as a separate tube in each cycle. In particular, moulded parts can be hereby produced in a particularly simple manner.

Three exemplified embodiments of the invention will be explained in more detail with the aid of the following description.

### BRIEF DESCRIPTION OF THE DRAWINGS

FIG. 1 shows a perspective and partly sectional view of a synthetic material pipe having a reinforcing structure embedded in the pipe wall in a first embodiment,

FIG. 2 shows an enlarged section of the partial section of the synthetic pipe of FIG. 1,

FIG. 3 shows a view of a cross-section through the pipe wall of a synthetic material pipe in a second embodiment, and

FIG. 4 shows a view of a cross-section through the pipe wall of a synthetic material pipe in a third embodiment.

### DESCRIPTION OF THE PREFERRED EMBODIMENTS

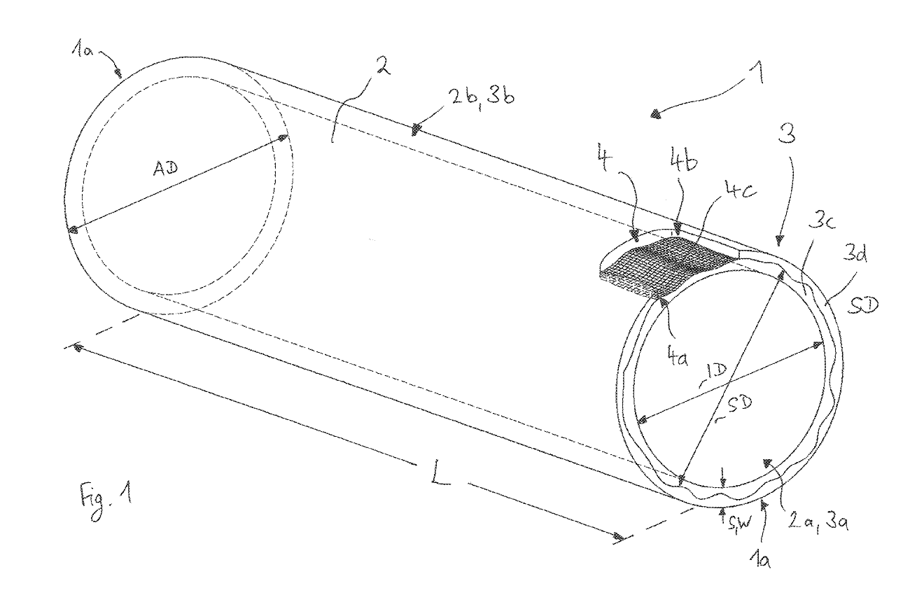

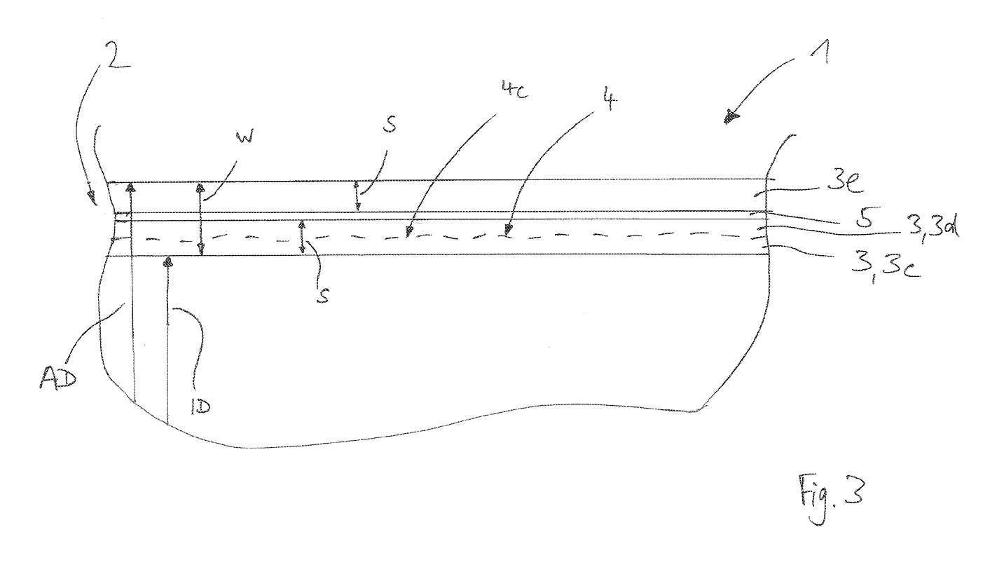

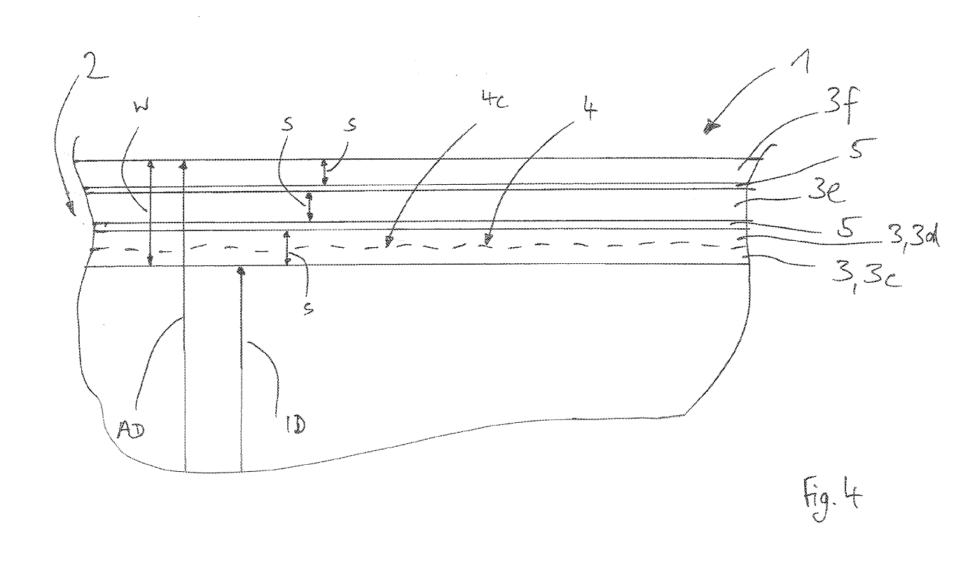

FIG. 1 shows a perspective view of a first embodiment of a reinforced synthetic material pipe 1, showing a partial section through the pipe wall 2 thereof. The synthetic material pipe 1 extends with a circular ring-shaped cross-section over a length L. The circular ring-shaped cross-section is formed by the pipe wall 2. The pipe wall 2 is formed with one layer and thus includes just a single layer 3 consisting of a synthetic material which, as a result, likewise has a circular ring-shaped cross-section. Of course, it is also possible to form the pipe wall 2 with multiple layers, i.e. not only with a single first layer 3, in that a second layer 3e (see FIG. 3), also additionally a third layer 3f (see FIG. 4) or even more layers is/are applied onto an inner surface 3a or an outer surface 3b of the first layer 3.

The synthetic material forming the layers 3, 3e and/or 3f of the pipe wall 2 substantially includes polymer material, preferably thermoplastic materials and thermosetting materials. The following materials are preferably used as the thermoplastic materials: polyolefins, e.g. polyethylenes (PE), in particular HDPE (abbreviation for “High Density Polyethylene”) or LDPE (abbreviation for “Low Density Polyethylene”), polyamides, in particular polyamide 12, or a compound comprising LDPE and polyamide, in particular polyamide 12. In the present case, a compound refers to a mixture of homogeneous polymer base materials, in particular different thermoplastic materials. One possible compound for the layers 3, 3e, 3f is also a mixture of at least one polymer base material with additional fillers, reinforcing materials or other additives. Alternatively, the synthetic material forming the layers 3, 3e, 3f can also include EVOH (abbreviation for “Ethylene Vinyl Alcohol Copolymer”). If one of the layers 3, 3e, 3f contains the aforementioned polyamide or EVOH material, then the gas permeability is hereby reduced and the oil resistance is increased in particular with respect to a layer 3, 3e, 3f consisting only of polyethylene, in particular HDPE or LDPE.

Compared with the production of a multi-layered synthetic material pipe, it is possible to produce such a simply designed, single-layered and reinforced synthetic material pipe 1 using fewer method steps, preferably using only one method step. According to the above definition of the term “layer”, the single-layered pipe wall 2 is formed by virtue of the fact that the synthetic material forming the first, and possibly single, layer 3 of the pipe wall 2 is solidified in only one method step. As seen in the longitudinal direction of the synthetic material pipe 1, the first layer 3 is delimited radially inwardly by the cylindrical inner surface 3a having an inner diameter ID and is delimited radially outwardly by the cylindrical outer surface 3b having an outer diameter AD. The outer surface 3b extends concentrically around the inner surface 3a at the distance of a layer thickness s. Owing to the single-layered design of the pipe wall 2, the inner surfaces 3a and the outer surface 3b of the layer 3 simultaneously form an inner surface 2a having the inner diameter ID and radially delimiting the pipe wall 2, and an outer surface 2b having the outer diameter AD. In a corresponding manner, the pipe wall 2 also has a wall thickness w corresponding to the layer thickness s.

In order to reinforce the synthetic material pipe 1, a reinforcing structure 4 is embedded in the first layer 3 of the pipe wall 2 over the entire length L between the inner surface 3a and the outer surface 3b and is surrounded by this layer 3 comprising an annular cross-section. The reinforcing structure 4 is tubular and is delimited by a peripheral surface having an average tube diameter SD. The tube diameter SD is greater than the inner diameter ID of the layer 3 and smaller than the outer diameter AD of the layer 3. The reinforcing structure 4 or together with its peripheral surface also has an extent in the direction of the length L which can correspond to, or be shorter than, the entire length L. The tubular reinforcing structure 4 as such can be formed to be flexible or rigid.

In accordance with the present understanding of the term “layer”, the synthetic material, previously plasticised to form a melt, of the first layer 3 of the pipe wall 2 is thus solidified only after the reinforcing structure 4 has been introduced in the plasticised synthetic material. When producing the first layer 3 or the single-layered pipe wall 2, the reinforcement thereof is directly associated as a result with the solidification of the first or single layer 3. A corresponding production method therefor is explained in more detail hereinafter.

Embedding the reinforcing structure 4 in the first layer 3 produces an inner region 3c and an outer region 3d of the layer 3, wherein the inner region 3c includes the synthetic material between the inner side 4a of the reinforcing structure 4 and the inner surface 3a of the layer 3 and the outer region 3d includes the synthetic material between the outer side 4b of the reinforcing structure 4 and the outer surface 3b of the layer 3. In particular, the reinforcing structure 4 is planarly and fixedly connected with an inner side 4a facing the inner surface 3a to the inner region 3c and with an outer side 4b facing the outer surface 3b to the outer region 3d, whereby a particularly stable embedding and connection of the reinforcing structure 4 to the first layer 3 of the pipe wall 2 is produced. In this manner, although the reinforcing structure 4 is arranged between the inner and outer regions 3c, 3d, the inner and outer regions 3c, 3d do not form two layers, according to the present definition of the term “layer”, owing to the conjoint solidification during the production and the planar connection produced via the reinforcing structure 4, but rather form merely one single first layer 3 in which the reinforcing structure 4 is integrated or embedded. The inner region 3c and the outer region 3d thus together form the single first layer 3 forming the pipe wall 2 and consisting of synthetic material and forming a tubular synthetic material matrix for the reinforcing structure 4 embedded therein. The reinforcing structure 4 can exit the first layer 3 or the pipe wall 2 merely at mutually opposite end faces 1a of the synthetic material pipe 1.

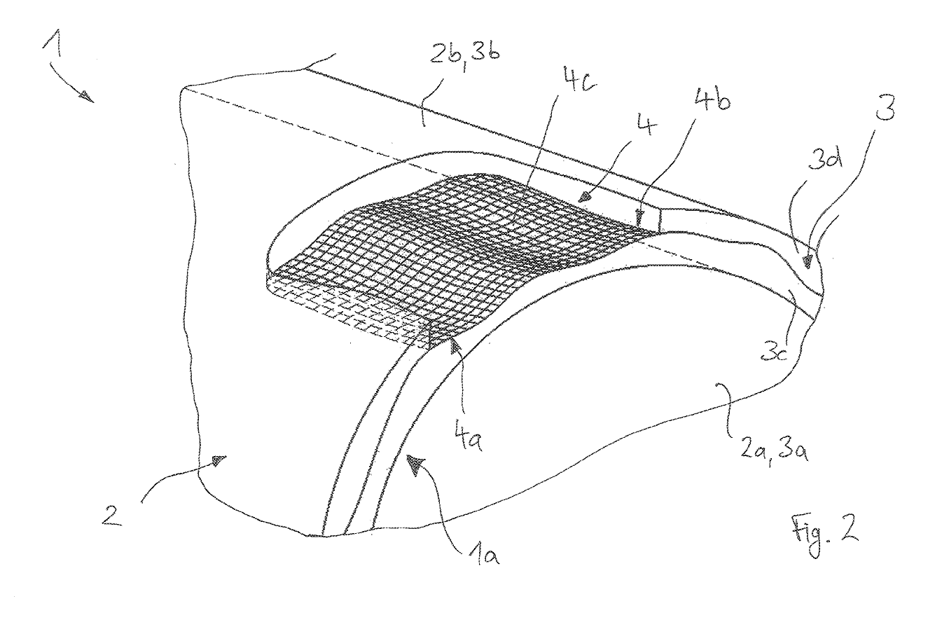

FIG. 2 illustrates an enlarged view of the partial section through the pipe wall 2 along the tubular reinforcing structure 4. In order for media such as gas, water or oil to be able to be conducted through the synthetic material pipe 1 at high pressure, the synthetic material pipe 1 has to have a high compressive strength which is achieved by a reinforcing structure 4 formed to have a high load bearing capacity. In order to be able to absorb the axial and tangential forces occurring in the pipe wall 2 in particular in the direction of the length L and transversely thereto in the circumferential direction, the reinforcing structure 4 is formed in a mesh-like manner in the illustrated exemplified embodiment. As a result, the reinforcing structure 4 includes at least two thread systems which cross at right angles or virtually at right angles. The threads extending substantially in a straight line in the direction of the length L are referred to as warp or warp threads. The threads extending substantially transverse thereto but in a spiral manner or at a constant tube diameter SD in helical form likewise in the direction of the length L are referred to as weft or weft threads. However, in principle, it is also feasible that the orientation of the warp threads and weft threads is swapped around so long as said forces can be absorbed. The design of the reinforcing structure 4 can be formed for example by a finite element calculation, which governs the ratios with respect to the number of warp threads, weft threads and outer diameter AD of the pipe wall 2 and the thickness of the respective threads.

The mesh-like reinforcing structure 4 forms stitches by the crossing warp and weft threads, which stitches are arranged over the peripheral surface of the tubular reinforcing structure 4 and along the length L, preferably evenly spaced apart from each other. The stitches can be dimensioned such that openings 4c in the reinforcing structure 4 are formed thereby, which openings are permeable for the synthetic material of the layer 3 which is present as a melt during the production of the synthetic material pipe 1 in plasticised form, and the synthetic material can flow through said openings. Owing to such openings 4c, which form a passage between the inner side 4a and the outer side 4b, the synthetic material flows around the threads forming the openings 4c of the mesh so that the reinforcing structure 4 and the first layer 3 of the pipe wall 2 penetrate via the openings 4c on opposite sides. Therefore, the inner region 3c and the outer region 3d are connected together seamlessly through the openings 4c in such a manner as to merge, whereby the layer 3 of the pipe wall 2 extends continuously and without interruptions at least partially between the inner surface 3a and the outer surface 3b, in particular in the region of the openings 4c.

It is also feasible for the reinforcing structure 4 not to be formed as a mesh, not forming any stitches, or no stitches sufficiently large for complete penetration and flowing-around to take place, and accordingly not forming any openings 4c and thus being closed in the region of the peripheral surface. The reinforcing structure 4 can thus be formed, in the region of the peripheral surface, as a permeable or impermeable tube for the synthetic material of the layer 3. As stated above, the inner and outer regions 3c, 3d—even if they are spatially separated from one another by an impermeable reinforcing structure 4—represent a single layer 3 in terms of the present invention because the two regions 3c, 3d are solidified conjointly during the production method, explained in more detail hereinafter, and are planarly connected together via the reinforcing structure 4.

The expression “mesh-like” is intended to also mean, in terms of the present invention, in particular a network structure or a lattice structure and a peripheral surface comprising punched-out portions, which surface can be formed, for example, from a tubular sheet, provided that the aforementioned axial and tangential forces are able to be absorbed thereby in each case. So long as this requirement is fulfilled, the tubular reinforcing structure 4 can likewise be produced dissimilarly from a core, netting, knitted fabric, knotted fabric, web, sewn fabric, non-woven material or felt. The stitches or openings 4c can also be formed, for example, to be in the shape of a rhombus, square or hexagon. In particular, the stitches or openings 4c can be knotted or knotless.

The reinforcing structure 4 can, in principle, be produced from any textile or textile-processed fibres, in particular threads, yarns or twine, e.g. from rubber fibres, metal fibres, natural fibres, fibres consisting of natural and synthetic polymers, preferably polyethylene, in particular UHMWPE (abbreviation for “ultra-high-molecular-weight polyethylene”) or even from glass fibres, carbon fibres or metal fibres, except from fibres consisting of nonferrous metals. However, it is also feasible for the reinforcing structure 4 to be formed not from a textile tube produced from fibres, with or without stitches or openings 4c, but e.g. from wire, in particular in the form of a tubular wire netting or wire mesh. In principle, the reinforcing structure 4 can also be produced from a sheet consisting of the aforementioned materials with or without openings 4c.

In particular, in the case of a reinforcing structure 4 produced from fibres, the planar, fixed connection to the layer 3 is also produced if the reinforcing structure 4 is not formed to be permeable as described above. This occurs by virtue of the fact that at least individual fibres, e.g. fibres of the weft and warp threads of a correspondingly dense mesh or fibres of a non-woven material or felt, are surrounded at the inner side 4a or outer side 4b in a form-fitting manner by the synthetic material of the layer 3. With sufficiently large stitches, which accordingly form permeable openings 4c of the reinforcing structure 4, the form-fitting connection is also produced using the entire weft and warp threads of the mesh-like reinforcing structure 4 and not only with individual surface fibres thereof.

Furthermore, FIGS. 1 and 2 illustrate at an end face 1a of the synthetic material pipe 1 the course of the tubular reinforcing structure 4 within the circular ring-shaped cross-section of the first layer 3 of the pipe wall 2 as seen in the direction of the length L. It becomes clear that the reinforcing structure 4, as seen in the longitudinal direction, does not have a constant radius in relation to a longitudinal axis of the synthetic material pipe 1 and accordingly also does not extend with its inner side 4a or outer side 4b in parallel with the inner surfaces 3a and outer surfaces 3b of the layer 3 but rather in a wave-like manner at varying distances therebetween. The varying distances result from the fact that the tubular reinforcing structure 4 is not formed in an inherently rigid and bending-resistant manner but in a flexible, in particular resilient or pliable, manner. Since the reinforcing structure 4 is introduced into the melt consisting of plasticised synthetic material during production and floats therein until the solidification of the molten layer 3 in an unstable or flexible manner with correspondingly varying distances to the inner surface 3a or outer surface 3b, the reinforcing structure 4 is only sufficiently supported by the solidification of the synthetic material melt and is fixed within the layer 3 in a dimensionally stable manner with distances which are then constant. However, provided that the reinforcing structure 4 has sufficient rigidity, it is also possible for the reinforcing structure 4 to have a constant radius over the entire length L of the synthetic material pipe 1. Accordingly, the reinforcing structure 4 can extend in a hollow cylindrical shape within the pipe wall 2 and in particular concentrically relative to the tubular layer 3 or at least in parallel with the inner surface 3a and outer surface 3b thereof. Also, a non-parallel, inclined orientation of the reinforcing structure 4 within the layer 3 is, in principle, feasible, provided that the inner surface 3a and the outer surface 3b are not penetrated by the reinforcing structure 4.

Two preferred variations of a method for producing the reinforced synthetic material pipe 1 in the first embodiment are described hereinafter. In both variations, it is possible for the reinforcement of the synthetic material pipe 1 or its single-layered pipe wall 2 to be terminated with the solidification of the plasticised synthetic material, surrounding the reinforcing structure 4, of the layer 3, without an additional method step for reinforcing the pipe wall 2 being subsequently required.

The synthetic material pipe 1 can be produced preferably by means of an extrusion method or by means of an injection moulding method. In each case, in a first method step, a synthetic material is melted or plasticised and is brought together as a melt with the already previously produced tubular reinforcing structure 4. The reinforcing structure 4 is arranged with respect to the synthetic material melt, subsequently solidifying to form the layer 3, such that the reinforcing structure 4 floats in the molten layer 3 in a completely immersed manner and the above-described design of the layer 3 with the reinforcing structure 4 floating or embedded therein is produced. In a second method step, the synthetic material, which is thus arranged around the reinforcing structure 4 and is still plasticised, of the layer 3 and the reinforcing structure 4 are formed into a corresponding tubular shape by means of a shaping tool which has the desired annular cross-section of the pipe wall 2. In a subsequent third method step, the layer 3 is then cooled in a targeted manner and solidified, whereby the reinforcing structure 4 is fixed within the layer 3 of the pipe wall 2 and thus becomes an integral component thereof.

In the case of an extrusion method, the reinforcing structure 4 is provided in the form of a tube and during the first method step of the extrusion process is continuously fed-in in the manner of an endless tube and is supplied to the extrusion process or the melt. A distribution, required for the above-described design, of the melt forming the layer 3 around the reinforcing structure 4 can be ensured in that only a supply of melt in the form of an extruder is provided and the melt is correspondingly distributed through the openings 4c formed in the reinforcing structure 4. Alternatively, an arrangement of at least two melt supplies in the form of two extruders can be provided which then each supply melt in the region of the inner side 4a and the outer side 4b of the reinforcing structure 4 (so-called co-extrusion). Then, in the second method step, the reinforcing structure 4 thus floating in the molten layer 3 is guided together with the melt through the shaping tool, which accordingly has an annular outlet opening, and is pressed onto a mandrel (not shown) for supporting the molten layer 3 which is not yet dimensionally stable. In the third method step, the layer 3 with the reinforcing structure 4 embedded therein is cooled, after exiting the tool, in the tubular shape produced by the tool and supported by the mandrel, and is solidified. In order to start the extrusion method, the tubular reinforcing structure 4 can be clamped during the first method step with an end face in a ring (not shown) corresponding to the desired pipe geometry, said ring then being used to thread the reinforcing structure 4 into the tool and subsequently being pressed through the tool by the following melt. It is also feasible to provide an annular port via which the reinforcing structure 4 is supplied to, and fed into, the melt.

In the case of an injection moulding method, the reinforcing structure 4 is placed and positioned in the shaping tool producing the tubular shape in each cycle as a separate tube section and is injection-moulded on the inner side 4a and also on the outer side 4b with melt of the synthetic material in order to form the inner and outer regions 3c, 3d of the layer 3 of the pipe wall 2. Since the reinforcing structure 4 is injection moulded and thus embedded in the layer 3 within the tool, the first and second method steps are at least partly superimposed. Then, in the third method step, the corresponding arrangement of the molten layer 3 and the reinforcing structure 4 embedded therein is solidified in the tool by cooling. As described above with respect to the extrusion method, it is possible to provide only one injection unit as a melt supply and the melt can be distributed through the openings 4c on both the inner side 4a and outer side 4b. Alternatively, a plurality of correspondingly arranged injection units can also be provided in order to effect a complete immersion or injection moulding of the reinforcing structure 4 and to form the inner region 3c and the outer region 3d of the layer 3. In particular, synthetic material pipes 1 having short lengths L of approximately 0.5 m, so-called fittings, are produced by means of an injection moulding method. Other synthetic material parts, which are in particular similar to pipes, can also be produced by means of the described injection moulding method as so-called moulded parts.

In order to ensure that the reinforcing structure 4 is arranged within the solidified first layer 3 forming the pipe wall 2, as described above, without the layer 3 being penetrated by the reinforcing structure 4, the reinforcing structure 4 floating in the melt can additionally be positioned and oriented in the tool, prior to solidifying the melt, e.g. by applying a traction force in the direction of the length L of the synthetic material pipe 1.

As stated above, it is also possible to form the pipe wall 2 with multiple layers, in that at least one further second layer 3d is applied onto the outer surface 3b of the layer 3 in a fourth method step.

FIG. 3 shows a view of a cross-section through the pipe wall 2 of a synthetic material pipe 1 in such a multi-layered second embodiment. In this case, the synthetic material pipe 1 or the pipe wall 2 thereof includes, preferably in addition to the inner first layer 3, an outer second layer 3e. The synthetic material of the first layer 3 substantially contains EVOH or preferably polyamide, in particular polyamide 12, or a compound consisting of polyethylene, in particular an LDPE or an HDPE, and polyamide, in particular polyamide 12. The synthetic material of the second layer 3e is preferably produced from polyethylene, in particular HDPE. Alternatively, the second layer 3e can also contain one of the other aforementioned synthetic materials if this does not already form the first layer 3. Alternatively, the first layer 3 can also be formed from polyethylene. By using the EVOH or polyamide, a barrier layer having the aforementioned advantages is formed by the corresponding layer 3 or 3e. Since at least one of the two layers 3 or 3e contains EVOH or polyamide, a suitable adhesion promoter 5 for the two layers 3, 3e is introduced between the first layer 3 and the second layer 3e, via which the two layers 3 and 3e can be connected together on a molecular level and in an integrally bonded manner. A thermoplastic material, in particular anhydride-modified ethylene, extruded onto the first layer 3, is used, for example, as the adhesion promoter 5.

Of course, it is also possible that the two layers 3, 3e are also each produced from a similar synthetic material, such as e.g. polyethylene, and therefore no adhesion promoter 5 is required to connect the two layers 3, 3e. However, in this case, at least the synthetic material of the first layer 3 must be able to be plasticised at a temperature lower than the temperature which is critical for the reinforcing structure 4 and the first layer 3 must have a layer thickness s which, after solidification, prevents damage to the reinforcing structure 4 owing to the higher temperatures of the second layer 3e applied in molten form. For example, the first layer 3 can be a polyethylene, in particular LDPE, having a melting point, also referred to as glass transition temperature, in the range between 90 and 120 degrees Celsius. The reinforcing structure 4 which is produced from polyethylene fibres, preferably UHMWPE fibres or yarn and is formed as a tubular mesh is embedded in the first layer 3. The reinforcing structure 4 produced from UHMWPE has a melting point of approximately 135 degrees Celsius and can thus be heated at the most to a critical temperature of 130 to 135 degrees Celsius in order not to be destroyed or for its molecular structure not to be damaged. The outer second layer 3e is applied onto the first layer 3, the synthetic material of the second layer substantially containing an HDPE and being connected to the first layer 3 in an integrally bonded manner. The melting point or glass transition temperature of the HDPE is approximately 135 degrees Celsius. However, since the molten HDPE is applied at processing temperatures, above the melting point, of 190 to 210 degrees Celsius, the first layer 3 is used not only to fix the reinforcing structure 4 but in particular is also used as a heat protection layer which prevents the polyethylene of the reinforcing structure 4 from being heated by the HDPE melt to the critical temperature range which is to be avoided. The reinforcing structure 4 can also be produced from UHMWPE if the first layer 3 is produced from a different synthetic material among those mentioned above.

FIG. 4 shows a view of a cross-section through the pipe wall 2 of a synthetic material pipe 1 in a three-layered third embodiment. The pipe wall 2 differs from the pipe wall 2 shown in FIG. 3 by a third layer 3f which is applied onto the second layer 3e in a fifth method step and is connected to the second layer 3e via an adhesion promoter 5 in an identical manner to how the first layer 3 is connected to the second layer 3e. For the remainder, the statements made with respect to the two-layered synthetic material pipe 1 apply, mutatis mutandis, to the three layers 3, 3e and 3f. Each of the three layers 3, 3e and 3f can thus, in principle, be produced from each of said synthetic materials, wherein preferably each layer 3, 3e, 3f contains a different synthetic material, or at least the central second layer 3e contains a different synthetic material, from that of the inner first layer 3 and the outer third layer 3f. Preferably, however, at least one of the three layers 3, 3e, 3f, in a particularly preferred manner the outer third layer 3f, includes polyethylene, in particular HDPE, or polyamide, in particular polyamide 12, in order to ensure the required strength of the synthetic material pipe 1 formed as a high-pressure pipe. In principle, however, all three layers, two of the layers or one of the layers 3, 3e and 3f can also be used as barrier layers by selecting the material accordingly.

However, the use of a reinforcing structure 4 consisting of a resistive material, but one which is heat-sensitive with respect to the temperatures mentioned above, e.g. a UHMWPE synthetic material, does not necessarily require the production of a second layer 3e but rather it is in principle also possible to form the pipe wall 2 with one layer and to produce it with only a single layer 3 consisting of one of said synthetic materials having the correspondingly required wall thickness w or layer thickness s. Of course, the pipe wall 2 can also be produced with a single layer 3 consisting of an HDPE synthetic material which can be processed in molten form only at higher temperatures, if the reinforcing structure 4 is non-heat-sensitive accordingly, e.g. in the case of a reinforcing structure 4 produced from wire or carbon fibres, glass fibres or aramid fibres. Irrespective of the specific material selection, the synthetic material of the first layer 3 must as a result in any case be able to be plasticised at a temperature lower than the temperature which is critical for the reinforcing structure 4 so as to form a melt which can be processed. The critical temperature is controlled by cooling the first layer 3. If the layers 3, 3e and/or 3f of the pipe wall 2 and the reinforcing structure 4 consist of the same materials, then the synthetic material pipe 1 can additionally be recycled in a simple manner.

In order to produce a corresponding two-layered or three-layered synthetic material pipe 1, the above-described methods can be supplemented merely by the fourth and possibly fifth method steps, in which the adhesion promoter 5 is applied, preferably extruded, onto the first layer 3 having the reinforcing structure 4 and the second layer 3e is applied, preferably extruded, thereon. In this case, the first layer 3 is molten superficially on the inner surface 3a or outer surface 3b, and therefore in this region the adhesion promoter 5 can mix with the melts of the first and second layers 3 and 3e and a molecular, integrally bonded connection between the two layers 3 and 3e is produced. The same applies to the application of the third layer 3f onto the second layer 3e and the application of the adhesion promoter 5 between the second and third layers 3e and 3f. In the case of correspondingly identical material, the adhesion promoter 5 can also be omitted. It is also feasible to apply the third layer 3f on the inside onto the first layer 3 or subsequently to improve the diffusion resistance of the inner first layer 3, e.g. by applying a so-called nano-coating.

The previously described synthetic material pipe 1 with a single-layered or multi-layered pipe wall 2 which is reinforced by the reinforcing structure 4 embedded in the first layer 3 is preferably used a high-strength, high-pressure pipe for conducting or transporting oil, gas and water. For this purpose, the dimensions of the synthetic material pipe 1 can be adapted to the respective intended use according to the requirements set forth in DIN 8074 (Polyethylene (PE) pipes—PE 80, PE 100—Dimensions). For example, the synthetic material pipe 1 can be designed for pressures of up to 60 bar and the pipe wall 2 can have an outer diameter AD of up to 800 mm. The layer thickness s of the thermoplastic layer 3, 3e or 3f is set by said DIN. If a second layer 3e and/or a third layer 3f is provided, the wall thickness w is increased and the inner diameter ID of the pipe wall 2 is reduced accordingly. The barrier layer which, in the case of a multi-layered pipe wall 2, is preferably formed by the first layer 3 has a layer thickness s of approximately 4 mm. An optionally provided adhesion promoter 5 is introduced between the layers 3, 3e and/or 3f, in each case with a thickness of 0.5 mm, whereby the inner diameter ID is correspondingly further reduced and the wall thickness w is increased (see FIGS. 3 and 4). By way of the described embedding of the reinforcing structure 4 in the first layer 3 and a corresponding selection of the materials used for the pipe wall 2 and the reinforcing structure 4, it is, however, in principle also possible—deviating from the specifications of DIN 8074—to reduce the layer thickness s of the first and single layer 3 of a single-layered pipe wall 2 and nevertheless to achieve the required mechanical strength or reliability of the synthetic material pipe 1.

The design described for the synthetic material pipe 1 having a reinforcing structure 4 embedded in the first layer 3 thereof can, of course, be applied to any other, in particular rotationally symmetrical, synthetic material bodies which can be produced by means of a method in accordance with the invention, in particular an extrusion method or injection moulding method. In particular, the annular cross-section of such a synthetic material body or synthetic material pipe 1 can also be oval or rectangular.

In principle, it is also feasible that the barrier layers include—instead of EVOH or polyamide—rubber, in particular synthetic rubber such as e.g. NBR (abbreviation for “nitrile butadiene rubber”), EPDM (abbreviation for “ethylene propylene diene monomer”), SBR (abbreviation for “styrene butadiene rubber”) or a compound comprising these rubbers or a selection of these rubbers.

### LIST OF REFERENCE NUMERALS

1 Synthetic material pipe
1a End face
2 Pipe wall
2a Inner surface
2b Outer surface
3 First layer
3a Inner surface
3b Outer surface
3c Inner region
3d Outer region
3e Second layer
3f Third layer
4 Reinforcing structure
4a Inner side
4b Outer side
4c Opening
5 Adhesion promoter
s Layer thickness
w Wall thickness
AD Outer diameter
ID Inner diameter
L Length
SD Tube diameter

1. A synthetic material pipe, which is formed as a high-pressure pipe, comprising a pipe wall, which includes a first layer consisting of a synthetic material, and a reinforcing structure arranged in the pipe wall, wherein the reinforcing structure is formed in a tubular manner and is embedded in the first layer, and can be obtained by introducing the reinforcing structure into the synthetic material, which is previously plasticized to form a melt, such that the reinforcing structure floats in the molten first layer in an unstable manner with varying distances to a cylindrical inner surface, radially inwardly delimiting the first layer, and to a cylindrical outer surface, radially outwardly delimiting the first layer, of the first layer, and is then sufficiently supported by solidification of the synthetic material melt and is fixed within the first layer, and thus in the pipe wall, in a dimensionally stable manner with distances which are then constant between the inner surface and the outer surface, such that the reinforcing structure has varying distances to the cylindrical inner surface and the cylindrical outer surface of the first layer and an inner region of the first layer includes the synthetic material between an inner side of the reinforcing structure and the cylindrical inner surface, and an outer region of the first layer includes the synthetic material between an outer side of the reinforcing structure and the cylindrical outer surface.

2. The synthetic material pipe as claimed in claim 1, wherein the reinforcing structure is formed in a mesh-like manner and comprises openings.

3. The synthetic material pipe as claimed in claim 1, wherein the first layer at least partially extends continuously between the inner surface and the outer surface.

4. The synthetic material pipe as claimed in claim 1, wherein the synthetic material of the first layer includes EVOH, polyamide, polyethylene, or a compound consisting of polyethylene and polyamide.

5. The synthetic material pipe as claimed in claim 1 4, wherein the pipe wall includes, in addition to the first layer in which the reinforcing structure is embedded, a second layer consisting of a synthetic material which is arranged on the outside on the first layer.

6. The synthetic material pipe as claimed in claim 5, wherein the pipe wall includes, in addition to the second layer, a third layer consisting of a synthetic material which is preferably arranged on the outside on the second layer, and wherein the synthetic material of the third layer includes EVOH, polyamide, polyethylene, or a compound consisting of polyethylene and polyamide, and wherein the second layer and third layer are connected via an adhesion promoter comprising a synthetic material which includes a thermoplastic material.

7. A method for producing a synthetic material pipe, which is formed as a high-pressure pipe, comprising:
embedding a tubular reinforcing structure in a first layer consisting of a molten synthetic material such that the reinforcing structure floats in the molten first layer in an unstable manner with varying distances to an inner surface and to an outer surface of the first layer;
forming the molten first layer and the reinforcing structure embedded and floating therein into a tubular shape having a cylindrical inner surface and cylindrical outer surface of the first layer; and
solidifying the first layer whereby the reinforcing structure is sufficiently supported by the solidification of the synthetic material melt and is fixed within the first layer, and thus in the pipe wall, in a dimensionally stable manner with distances which are then constant, such that the reinforcing structure has varying distances to the cylindrical inner surface and the cylindrical outer surface of the first layer and an inner region of the first layer includes the synthetic material between an inner side of the reinforcing structure and the cylindrical inner surface, and an outer region of the first layer includes the synthetic material between an outer side of the reinforcing structure and the cylindrical outer surface.

8. The method as claimed in claim 7, wherein the synthetic material of the first layer includes EVOH, polyamide, polyethylene, or a compound consisting of polyethylene and polyamide, and wherein the reinforcing structure includes polyethylene.

9. The method as claimed in claim 7, further comprising applying a second layer consisting of a molten synthetic material onto the outside of the first layer, and the synthetic material of the second layer includes EVOH, polyamide, polyethylene, or a compound consisting of polyethylene and polyamide, and wherein an adhesion promoter consisting of a molten synthetic material that comprises a thermoplastic material is introduced between the first layer and the second layer.

10. The method as claimed in claim 9, further comprising applying a third layer consisting of a molten synthetic material onto the outside of the second layer, and the synthetic material of the third layer includes EVOH, polyamide, polyethylene, or a compound consisting of polyethylene and polyamide, and wherein an adhesion promoter consisting of a molten synthetic material that comprises a thermoplastic material is introduced between the second layer and the third layer.

11. The method as claimed in claim 7, wherein the method is performed in an extrusion method to which the tubular reinforcing structure is continuously supplied.

12. The method as claimed in claim 7, wherein the method is performed in an injection moulding method to which the tubular reinforcing structure is supplied as a separate tube in each cycle.

13. The method of claim 10, wherein the polyamide of the first layer, the second layer, or the third layer comprises polyamide 12, and/or the polyethylene of the first layer, the second layer, or the third layer comprises an LDPE or an HDPE.

14. The method of claim 10, wherein the adhesion promoter introduced between the first layer and the second layer and/or the adhesion promoter introduced between the second and third layer comprises anhydride-modified ethylene.

15. The synthetic material pipe of claim 3, wherein the first layer at least partially extends continuously between the inner surface and the outer surface in the region of the openings in the reinforcing structure.

16. The synthetic material pipe of claim 4, wherein the polyamide of the first layer comprises polyamide 12 and/or the polyethylene of the first layer comprises an LDPE or an HDPE.

17. The synthetic material pipe of claim 5, wherein the synthetic material of the second layer includes EVOH, polyamide, polyethylene, or a compound consisting of polyethylene and polyamide.

18. The synthetic material pipe of claim 17, wherein the reinforcing structure includes polyethylene.

19. The synthetic material pipe of claim 18, wherein the first and second layer are connected by an adhesion promoter that comprises a thermoplastic material.

20. The synthetic material pipe of claim 6, wherein the thermoplastic material of the adhesion promotor connecting the second layer and third layer includes anhydride-modified ethylene.
